(19) United States
(12) Patent Application Publication
(10) Pub. No.: US 2020/0302071 A1
(43) Pub. Date: Sep. 24, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Tadao MICHIMURA, Kanagawa (JP); Norio YAMAMOTO, Kanagawa (JP); Naoyuki ENOMOTO, Kanagawa (JP); Shinya NAKAMURA, Kanagawa (JP); Jun ANDO, Kanagawa (JP)

(73) Assignee: FUJI XEROX CO., LTD., Tokyo (JP)

(21) Appl. No.: 16/521,539

(22) Filed: Jul. 24, 2019

(30) Foreign Application Priority Data
Mar. 20, 2019 (JP) 2019-053830

(51) Int. Cl. G06F 21/62; G09B 5/00; G06K 9/00; G06F 21/32

(52) U.S. Cl. CPC G06F 21/6209; G09B 5/00; G06K 9/00288; G06F 21/32; G06K 9/00275

(57) ABSTRACT

An information processing apparatus includes an authentication section that authenticates a member who gives a presentation based on information obtained at a place in which the presentation is given; a linking section that links the authenticated member to an image of the presentation; and a presentation section that presents a link between the authenticated member and the image of the presentation.

### CROSS-REFERENCE TO RELATED APPLICATIONS

This application is based on and claims priority under 35 USC 119 from Japanese Patent Application No. 2019-053830 filed Mar. 20, 2019.

### BACKGROUND

### (i) Technical Field

The present invention relates to an information processing apparatus and a non-transitory computer readable medium storing a program.

### (ii) Related Art

In recent years, it is required to obtain and develop ability to play an active part in a group while valuing diversity. As one method, group learning in which a solution to a problem not having a clear answer is discussed with various members is widely adopted. In the group learning, in general, members gathered in an ad hoc manner discuss based on their knowledge and experience, and present a result of the discussion as an output at the end of the discussion. In many cases, an output of the group learning is written on a whiteboard generated in a process of discussion or is a handwritten thing such as vellum paper, and is also used for a presentation.

Examples of related art include JP2012-209867A.

### SUMMARY

Since a member of a group is determined each time of a group learning in an ad hoc manner, it takes time to associate the group with the member. Although an identifier such as a student identification number is given to a participant in the group learning in advance, the participant may make a mistake or forget to write the student identification number. In addition, since a member of the group learning may be confirmed later or a relationship between the group and the output may be made later, it becomes difficult to confirm the factual relationship as a time passes from the presentation.

Aspects of non-limiting embodiments of the present disclosure relate to an information processing apparatus and a non-transitory computer readable medium storing a program capable of improving accuracy of a link between a presented output and a member involved in generation of the output as compared with a case where the link between the output and the member involved in generation of the output cannot be performed at that day.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: an authentication section that authenticates a member who gives a presentation based on information obtained at a place in which the presentation is given; a linking section that links the authenticated member to an image of the presentation; and a presentation section that presents a link between the authenticated member and the image of the presentation.

### BRIEF DESCRIPTION OF THE DRAWINGS

Exemplary embodiment(s) of the present invention will be described in detail based on the following figures, wherein:

FIG. 1 is a diagram for explaining a conceptual configuration of an information processing system used in Exemplary Embodiment 1;

FIG. 2 is a diagram for explaining a configuration example of a teacher terminal, a student terminal, a management server, and a learning result registration support apparatus;

FIG. 3 is a diagram for explaining an example of functional configuration of a control unit constituting the learning result registration support apparatus used in Exemplary Embodiment 1;

FIG. 4 is a flowchart illustrating an example of a processing operation executed by the learning result registration support apparatus used in Exemplary Embodiment 1;

FIG. 5 is a diagram for explaining a technology of specifying a student or an output imaged in a group image;

FIG. 6 is a diagram for explaining an example of a screen presenting a linking relationship between an output and a student;

FIG. 7 is a diagram for explaining a conceptual configuration of an information processing system used in Exemplary Embodiment 2;

FIG. 8 is a diagram for explaining an example of a functional configuration of a control unit constituting the learning result registration support apparatus used in Exemplary Embodiment 2;

FIG. 9 is a flowchart illustrating an example of a processing operation executed by the learning result registration support apparatus used in Exemplary Embodiment 2;

FIG. 10 is a diagram for explaining a scene of reading a fingerprint of a student; and

FIG. 11 is a diagram for explaining an example of a screen displayed after reading of the fingerprint is completed.

### DETAILED DESCRIPTION

Hereinafter, exemplary embodiments of the present invention will be described with reference to drawings.

### Exemplary Embodiment 1

Overall Configuration of System

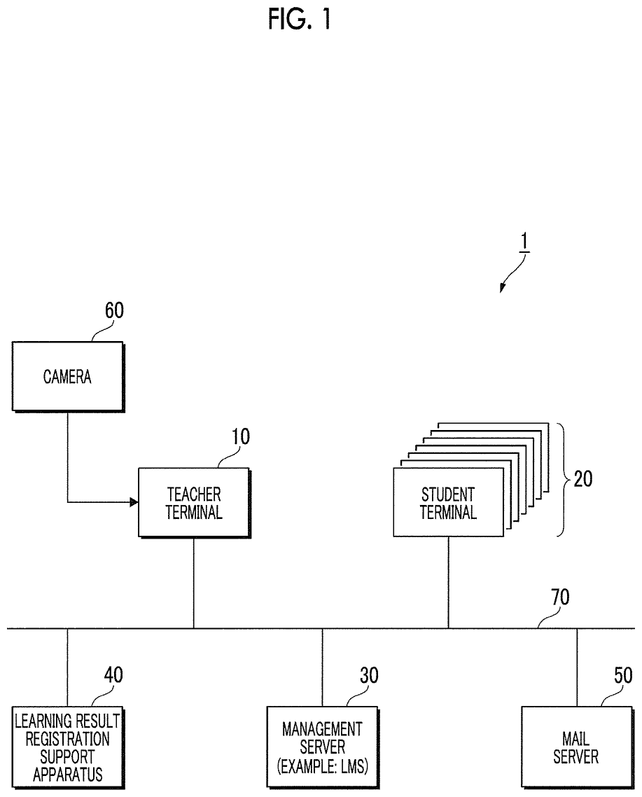

FIG. 1 is a diagram for explaining a conceptual configuration of an information processing system 1 used in Exemplary Embodiment 1. It is assumed that the information processing system 1 illustrated in FIG. 1 is used in an educational institution. The information processing system 1 is configured to include a terminal 10 operated by a teacher, a plurality of terminals 20 operated by students, a management server 30 which manages management data, a learning result registration support apparatus 40 which supports registration of a result of group learning, a mail server 50 which delivers an e-mail, and a camera 60 used for imaging an output of the group learning or a status of presentation.

In a case of the present exemplary embodiment, an example of a method of presenting an output includes, for example, a method of displaying or posting a paper medium in which a document, a figure, or the like is handwritten or printed on a wall, a method of handwriting and presenting a document, a figure, or the like on a whiteboard or a blackboard, a method of projecting a document, a figure, or the like on a wall by using a projector, a method of displaying a document, a figure, or the like on a display, a method of displaying an article as an output, and the like.

Therefore, an output in the present exemplary embodiment is not limited to a type such as paper or a slide, but includes electronic data and an article. The article includes a natural product as well as a product generated by a student.

In the present exemplary embodiment, it is assumed that group learning is a form of group activity.

In the present exemplary embodiment, the terminal 10 is also referred to as a teacher terminal 10, and the terminal 20 is also referred to as a student terminal 20. In a case in FIG. 1, the number of teacher terminals 10 is one, but the number of teacher terminals 10 constituting the information processing system 1 may be more than one.

All of the teacher terminal 10, the student terminal 20, the management server 30, the learning result registration support apparatus 40, and the mail server 50 are connected via a network 70.

Both of the teacher terminal 10 and the student terminal 20 are computers capable of performing a network connection. The computer may be a stationary computer or a portable computer. It is assumed that the portable computer is, for example, a notebook computer, a tablet computer, or a smartphone.

The management server 30 in the present exemplary embodiment manages data of a learning management system (LMS) and data of a teaching system. The data of the LMS includes a history of learning, image data obtained by imaging an output, a record of attendance, a record of submission of a task, and the like. In addition, the data of the teaching system includes a record of study, a grade, a school year, an undergraduate, a department, a major, and the like.

Information stored in the management server 30 can be browsed by the teacher terminal 10 and the student terminal 20. For example, in the teacher terminal 10, it is possible to browse a grade of a student managed by the management server 30. In addition, in the teacher terminal 10, it is possible to upload a learning material or to register a result of group learning for the management server 30. Further, in the student terminal 20, it is possible to browse the learning material, an own grade, or the like managed by the management server 30.

The learning result registration support apparatus 40 is a computer which provides a service for supporting a link between image data obtained by imaging an output of group learning and a student involved in production of the output by cooperating with the teacher terminal 10, the student terminal 20, the management server 30, and the mail server 50.

For example, the learning result registration support apparatus 40 has a function of supporting registration of a member in a group, a function of supporting a link between image data of an output and the corresponding group, and the like.

The learning result registration support apparatus 40 is an example of an information processing apparatus which supports registration of a result of a group activity.

The mail server 50 is a server which distributes an e-mail transmitted from the learning result registration support apparatus 40 to a student designated as a destination. In a case of the present exemplary embodiment, the e-mail is used to notify absence for a student who is regarded as an absentee.

The camera 60 is a device which images a picture as a still image or a moving image. The camera 60 includes an optical system for imaging light reflected by an object, an image sensor for converting the imaged light into an electric signal, and an analog-to-digital converting circuit for converting the electric signal into digital data. The converted digital data is recorded, for example, in a storage medium mounted to the camera 60. For example, a complementary metal oxide semiconductor (CMOS) image sensor or a charged-coupled devices (CCD) image sensor is used as an image sensor.

As described above, the camera 60 is used for imaging an output or the like. Meanwhile, an image scanner may be used for imaging an output. Meanwhile, it is premised that a shape or a dimension of the output can be read by the image scanner.

The image scanner includes, for example, a light source which outputs linear illumination light, an image sensor which converts the illumination light (that is, reflected light) reflected by an output into an electrical signal, and a moving mechanism which integrally moves the light source and the image sensor, and an analog-to-digital converting circuit which converts the electrical signal into digital data. The illumination light is moved along a surface of the output by the movement of the light source and the image sensor by the moving mechanism.

The network 70 is, for example, an internet or a local area network (LAN). The network 70 may be wireless or wired.

Configuration of Each Apparatus

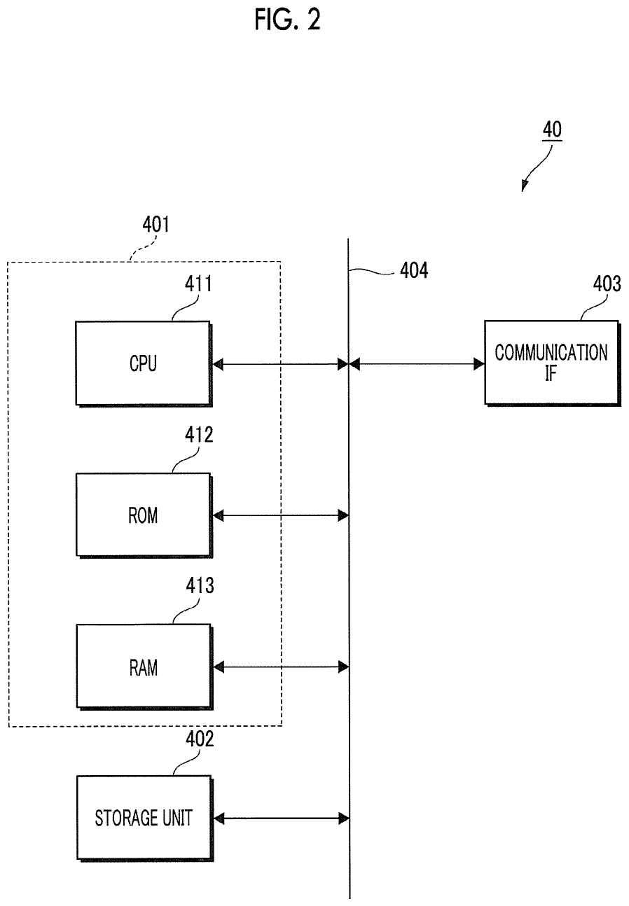

FIG. 2 is a diagram for explaining a configuration example of the teacher terminal 10 (see FIG. 1), the student terminal 20 (see FIG. 1), the management server 30 (see FIG. 1), and the learning result registration support apparatus 40. As described above, all of the teacher terminal 10, the student terminal 20, the management server 30, and the learning result registration support apparatus 40 have a computer as a basic configuration. The configuration illustrated in FIG. 2 corresponds to a configuration of the learning result registration support apparatus 40 as a representative example.

The learning result registration support apparatus 40 includes a control unit 401 which controls an operation of the entire apparatus, a storage unit 402 which stores data, and a communication interface (communication IF) 403 which realizes communication via a LAN cable or the like.

The control unit 401 includes a central processing unit (CPU) 411, a read only memory (ROM) 412 which stores firmware, a basic input output system (BIOS), and the like, and a random access memory (RAM) 413 used as a work area. The CPU 411 may have a multi-core. In addition, the ROM 412 may be a rewritable non-volatile semiconductor memory.

The storage unit 402 is a non-volatile storage device, and is configured to include, for example, a hard disk device, a semiconductor memory, and the like. In a case of the present exemplary embodiment, the storage unit 402 stores image data obtained by imaging an output, image data obtained by imaging a member involved in generation of the output, and the like.

The control unit 401 and each unit are connected through a bus 404 or a signal line (not illustrated).

The management server 30 in the present exemplary embodiment also has the same configuration as the learning result registration support apparatus 40.

In the present exemplary embodiment, as an additional configuration, the teacher terminal 10 and the student terminal 20 include a display unit used for displaying an operation screen or the like and an operation receiving unit for receiving an operation of a user.

The display unit is formed of, for example, a liquid crystal display, an organic EL display, or the like. The display unit may be integrated with bodies of the terminals 10 and 20 or may be connected to the bodies of the terminals 10 and 20 as an independent device.

In addition, as the operation receiving unit, a keyboard used for inputting a text, a mouse used for inputting movement, selection, or the like of a pointer on a screen, a touch sensor, and the like are used.

In a case of the present exemplary embodiment, an operation on the learning result registration support apparatus 40 is input by using the display unit of the teacher terminal 10 and the operation receiving unit.

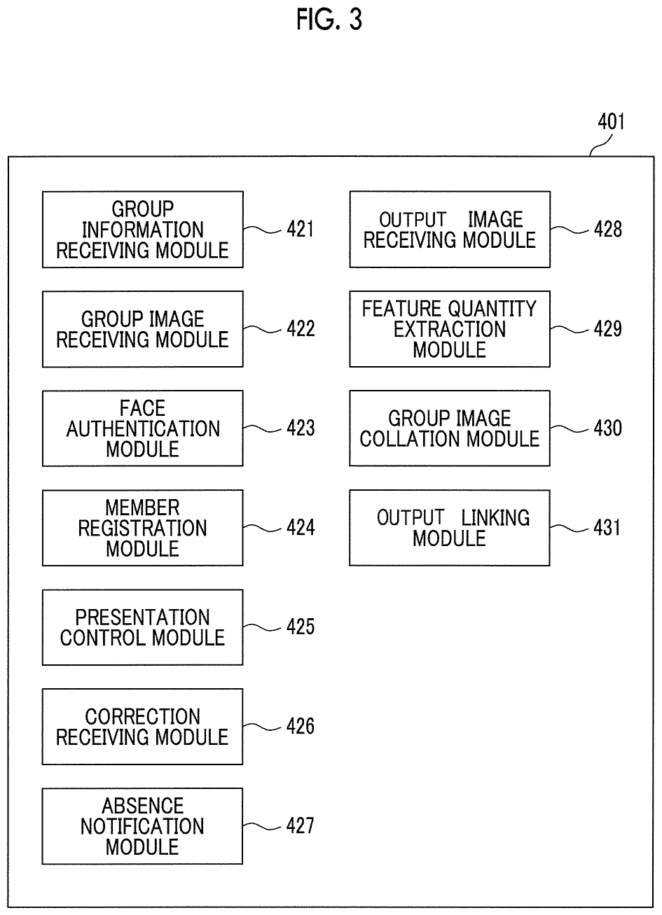

FIG. 3 is a diagram for explaining an example of a functional configuration of the control unit 401 constituting the learning result registration support apparatus 40 used in Exemplary Embodiment 1. A module illustrated in FIG. 3 is realized by a program being executed by the CPU 411 (see FIG. 2).

The module illustrated in FIG. 3 is a part of the program executed by the control unit 401.

One of the modules illustrated in FIG. 3 is a group information receiving module 421 which receives information on a prospective participant in group learning, the number of groups used in the group learning, and the like.

Information of the prospective participant who participates in the group learning is designated through the teacher terminal 10. Here, the information of the prospective participant includes, for example, the number of students, a name of the student, an e-mail address of the student, a student identification number assigned to the student, and other identification information. In some cases, the information such as the name of the student may be input as text data by a teacher, or may be selected from a list of names or the like displayed on an operation screen.

Image data of an e-mail address of a student or a face of the student (hereinafter, also referred to as “face image data”) is linked to a name or the like of the student and is managed by the management server 30 (see FIG. 1). For this reason, in a case of knowing the name or the like of the student, it is possible to read out the e-mail address and the face image data from the management server 30 (see FIG. 1).

In a case where group learning is convened in class units, information on a prospective participant in the group learning may be designated by a class name. In a case of knowing the class name, it also becomes possible to determine the name or the like of the student.

The number of groups may be designated through the teacher terminal 10, or may be calculated by the learning result registration support apparatus 40 (see FIG. 1) based on the number of accepted students.

One of the modules illustrated in FIG. 3 is a group image receiving module 422 which receives an image (hereinafter, also referred to as “group image”) obtained by imaging a member of a group.

The group image is an example of information obtained at a venue in which presentation of an output is performed, and is also an example of a second image.

In a case where the camera 60 (see FIG. 1) is connected to the teacher terminal 10, image data imaged by the camera 60 is transmitted to the learning result registration support apparatus 40 via the teacher terminal 10 and the network 70 (see FIG. 1).

Meanwhile, in a case where the camera 60 is directly connected to the learning result registration support apparatus 40, image data imaged by the camera 60 can be directly transmitted to the learning result registration support apparatus 40. In addition, in a case where the camera 60 is connectable to the network 70, it is also possible to transmit the image data imaged by the camera 60 to the learning result registration support apparatus 40 via the network 70.

In a case of the present exemplary embodiment, a photographer of the group image is a teacher. Meanwhile, the photographer may be a representative of each group. In this case, for example, a representative of a group images a group image including itself and a member of the group by using a selfie function of a smartphone. In addition, the photographer may be a student who belongs to a group other than the group to be imaged.

The group image is imaged until a student who presents an output of group learning leaves a venue.

Imaging of the group image may be performed before presentation of the output, during the presentation of the output, or after the presentation of the output. Discussion in the group is also included in “before the presentation of the output”.

There is a possibility that results of all of groups cannot be presented due to a time limit or the like. Even in this case, before a student of a group of which a result cannot be presented leaves the venue, a group image including a part of an output to the extent that collation is possible is imaged.

In the present exemplary embodiment, a group image captured at a venue for a group of which a result cannot be presented is also treated as information obtained at the venue in which presentation of an output is performed.

The group image received by the group image receiving module 422 is, for example, a group photo in which all members constituting a group are imaged.

The group photo is used not only to specify the member of the group but also to link the specified member with image data of the output.

For this reason, it is required that a part of the output to the extent that collation with image data obtained by imaging the entire output is possible is imaged in at least one group photo. The degree to which collation is possible is a degree to which a certain output can be specified, and is not required that the output can be uniquely identified. In a case where the output cannot be uniquely specified, a teacher or a student visually determines a link between the output and a member.

In a case of the present exemplary embodiment, it is not necessary for one group photo to show all of members constituting the group. In other words, a group photo may be a set of a plurality of photos in which a common person is imaged.

For example, a representative of the group may perform presentations of the output, while other members may be away from the representative in the presentation. In this case, a photo of the representative who performs presentation in front of the output and a photo in which the representative and other members are imaged together are treated as a group photo. A photo in which a presenter and a student A are imaged together and a photo in which the student A and a student B are imaged together are treated as group photos.

For example, a teacher or the like designates a plurality of photos treated as group photos. Candidates of the plurality of photos treated as group photos may be extracted by an image process and may be presented to a teacher or the like.

The group photo may be a moving image obtained by imaging a member moving to align with a podium or a teaching desk to present an output, or may be a plurality of photos obtained by consecutively imaging a status of the movement. These photos are obtained by imaging, for example, with the camera 60 (see FIG. 1) disposed in a passage through which the members go to the podium or the like. Further, these photos are obtained so that faces of the members are imaged.

In addition, a status of the presentation of the output may be imaged as a moving image.

In a case of the present exemplary embodiment, a group photo of a member in a group and an output is obtained by imaging in group units while a student participating in group learning is in a venue in which the output is presented, and is given to the group image receiving module 422 in real time.

As described below, linking of image data obtained by imaging the entire output and a member of the group involved in generation of the output is performed in real time. For this reason, while the member of the group is in the venue, it is possible to check a correctness of a result of the linking.

One of the modules illustrated in FIG. 3 is a face authentication module 423 which extracts an image of a face from image data so as to authenticate a student.

As described above, face image data of the student is managed by the management server 30 (see FIG. 1) or the like. The face authentication module 423 authenticates a student belonging to a group by collation of the face image data and the face imaged in group image. The face authentication module 423 is an example of an authentication section.

One of the modules illustrated in FIG. 3 is a member registration module 424 which registers the student specified by face authentication into the group. The registration is a temporary registration. The registration of the member is determined after confirmation of a teacher or a student.

One of the modules illustrated in FIG. 3 is a presentation control module 425 which displays information of students registered as members of the same group on a display of the teacher terminal 10 (see FIG. 1) and on a display of the student terminal 20 (see FIG. 1).

In a case of the present exemplary embodiment, the presentation control module 425 displays a list of names of students registered as members in the same group, on the display of the teacher terminal 10 and the display of the student terminal 20 registered in the group to be presented. The presentation can also be performed by an e-mail being transmitted.

The presentation of the list of the names or the like of the student is performed, for example, after presentation of the output.

The presentation control module 425 also has a function of displaying a message of a case where the number of groups in which members are registered is less than the number of groups set in advance, on the display of the teacher terminal 10 (see FIG. 1).

This type of display may occur, for example, in a case where a group photo is not obtained due to imaging of a member constituting a group being forgotten. With this function, it is possible to obtain the group photo by imaging the corresponding group at the corresponding place and to register the member.

Further, the presentation control module 425 also has a function of presenting a linking relationship between the output and the group by an output linking module 431 to be described below. Here, names of the students constituting the group to which the output is linked are presented. The presentation control module 425 is an example of a presentation section.

One of the modules illustrated in FIG. 3 is a correction receiving module 426 which receives a correction in a case where there is an error in the presented content. Here, an example of the error includes an error in the number of persons, an error in students registered in the group, and the like. For example, in a case where all members are not imaged in a group photo, the number of recognized members is short of the original number of members. In addition, for example, in a case where a student other than the members is imaged in the group photo, the number of recognized members exceeds the original number of members. Further, for example, in a case where a member imaged in the group photo does not face front, there is a possibility that face authentication of the student may be incorrect.

In the present exemplary embodiment, a student who notices an error notifies a teacher of the error in the presented content and a correct content. Here, the notification may be a verbal notification, a notification by an e-mail, or a notification using a screen for notification.

In a case of the present exemplary embodiment, correction of the presented content is possible only at the teacher terminal 10 (see FIG. 1).

A content after the correction is displayed again on a display of the student terminal 20 (see FIG. 1) registered as a member of the group.

One of the modules illustrated in FIG. 3 is an absence notification module 427 which regards a student who is not registered in any group as absences, among students who are accepted in advance, and notifies the corresponding student terminal 20 (see FIG. 1).

The notification by the absence notification module 427 is also performed in real time. For this reason, it is possible for the corresponding student to notice that the student is regarded as an absentee while the student is at the venue.

A student who receives a notification of absence despite participating in group learning, for example, reports on this to the teacher along with other members. The teacher confirms a testimony of the other members, an imaged photo, or the like, and instructs correction of the registered content. The correction instruction is received by the correction receiving module 426 described above.

One of the modules illustrated in FIG. 3 is an output image receiving module 428 which receives image data obtained by imaging an entire output.

In a case of the present exemplary embodiment, image data of an output is captured separately from a group photo of a member of a group. For example, after an output from each group is submitted, the output is imaged. In addition, the submission of the output is not limited after presentation. For example, the output may be submitted before presentation.

In addition, in a case where the group photo is imaged and the entire output is imaged as a part of a background of a member, it is also possible to receive the area portion as the image data of the output. Meanwhile, in this case, it is necessary for a teacher to designate the area portion to be received as the output. Further, in a case where the output is prepared as electronic data, the electronic data may be received.

The output image receiving module 428 used in the present exemplary embodiment has a function of notifying that the number of pieces of image data of an output is insufficient in a case where the number of pieces of the image data of the received output is smaller than the number of groups set in advance, to the teacher terminal 10 (see FIG. 1). This notification occurs, for example, in a case where there is a group of which an output is forgotten to submit, in a case where a teacher omits imaging or registration of the output, or the like.

One of the modules illustrated in FIG. 3 is a feature quantity extraction module 429 which extracts a feature quantity from image data obtained by imaging an output.

The feature quantity in the present exemplary embodiment is measurable information used to identify an individual.

An example of the feature quantity is a layout of an output. In a case where the output is a sheet, the layout is defined by, for example, a position or a size of a text, a symbol, a figure, a table, or the like in the sheet. In a case where the output is a three-dimensional product, the layout is defined by, for example, a shape of an appearance, a shape appearing on a specific surface, a pattern, a color, and a combination thereof.

Another example of the feature quantity is a ratio of an area in which a text and the like are described to a surface area of the output. For example, in a case where a text or the like is described in black on a sheet of white paper, the ratio is defined by a ratio of an area of black appearing in an area of the sheet.

Another example of the feature quantity is a distribution of a ground color of the output and a color used to describe a content. The distribution of colors is defined, for example, by a ratio of areas by the color used for the output.

Another example of the feature quantity is a partial image of the output. The partial image is defined, for example, by a position and a size in the whole, a pattern of an image, and the like.

One of the modules illustrated in FIG. 3 is a group image collation module 430 which collates a feature quantity extracted from image data of the output with image data obtained by imaging a status of presentation.

As described above, a group photo used to specify a member constituting a group includes a part of an output to the extent that collation with image data obtained by imaging the entire output is possible.

The group image collation module 430 collates the group photo with the feature quantity to determine image data of the output to be linked to the group photo. That is, the image data of the output to be associated with the group is determined.

In a case where a plurality of pieces of image data having a high possibility of being similar to the output imaged in the group photo is found, the group image collation module 430 notifies that there are a plurality of pieces of image data having high similarity, to the teacher terminal 10 (see FIG. 1). The teacher confirms a content of the image and inputs an instruction of the image data to be associated.

One of the modules illustrated in FIG. 3 is the output linking module 431 which links an output to a corresponding group based on a result of collation. The output linking module 431 is an example of a linking section.

The output linking module 431 according to the present exemplary embodiment has a function of presenting a screen presenting images of outputs linked to the same group and a list of names and the like of students on the teacher terminal 10 or the like. The presentation of this screen is also performed in real time. That is, the presentation is performed while the students who participate in group learning stay at a venue in which the output is presented.

For this reason, a correctness of a linking relationship is immediately confirmed at a place at which the output is presented.

### Example of Processing Operation

Hereinafter, a processing operation executed in Exemplary Embodiment 1 will be described.

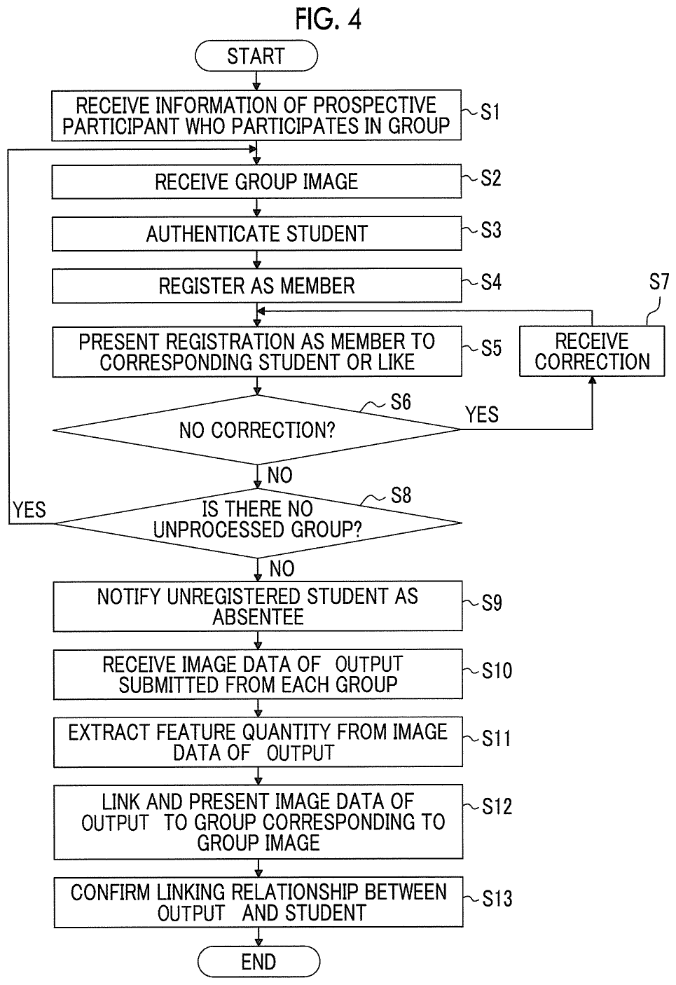

FIG. 4 is a flowchart illustrating an example of a processing operation executed by the learning result registration support apparatus 40 (see FIG. 1) used in Exemplary Embodiment 1. S illustrated in the flowchart means a step.

In a case of the example illustrated in FIG. 4, the learning result registration support apparatus 40 receives information of a prospective participant who participates in group learning (step S1). In a case of the present exemplary embodiment, information such as the number of students, names of the students, or the like is obtained from the teacher terminal 10 (see FIG. 1).

Next, the learning result registration support apparatus 40 receives a group image (step S2). In a case of the present exemplary embodiment, the group image is captured by the camera 60 (see FIG. 1).

The learning result registration support apparatus 40 which receives the group image authenticates a student imaged in the group image (step S3). In a case of the present exemplary embodiment, authentication of the student is performed by face authentication.

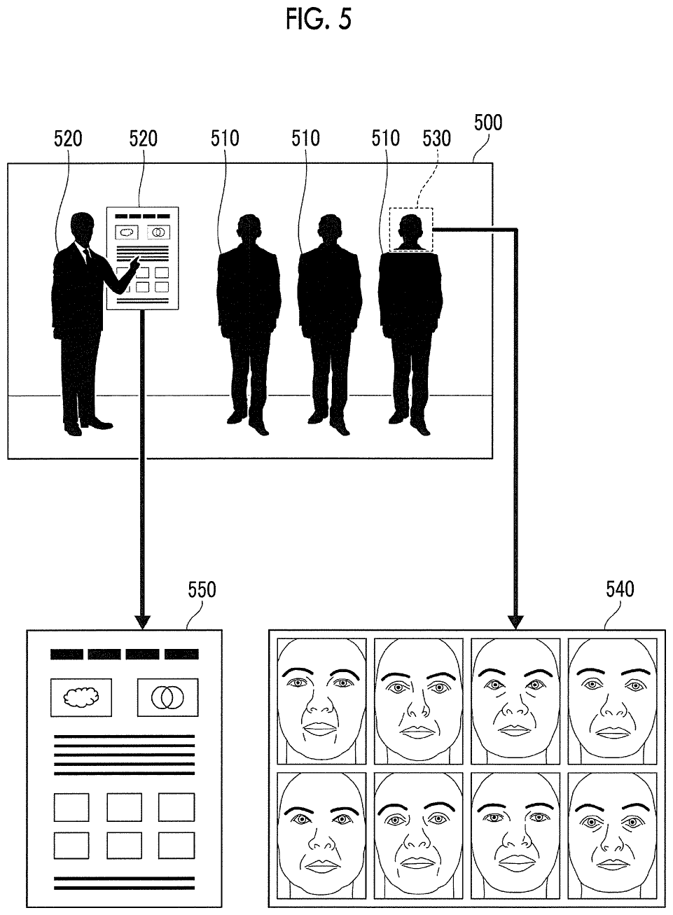

FIG. 5 is a diagram for explaining a technology of specifying a student or an output imaged in a group image 500. In the group image 500 illustrated in FIG. 5, four students 510 are imaged, and one of the students performs presentation in front of an output.

The learning result registration support apparatus 40 collates a face image 530 imaged by a dashed line with a face image database 540 stored in the management server 30 (see FIG. 1), and authenticates each student 510 imaged in the group image 500 one by one.

FIG. 5 also illustrates a status in which image data 550 obtained by imaging the entire output and an output image 520 included in the group image 500 are collated with each other. The collation of the image data 550 obtained by imaging the entire output and the output image 520 included in the group image 500 will be described below.

Returning to the description in FIG. 4.

In a case where the face authentication of the student imaged in the group image is completed, the learning result registration support apparatus 40 registers all of the students specified by the face authentication as members of a certain group (step S4). As described above, the registration is a temporary registration.

Thereafter, the learning result registration support apparatus 40 presents the registration as the member to the corresponding student or the like (step S5). In a case of the present exemplary embodiment, a registered content is notified to both of the teacher terminal 10 (see FIG. 1) and the student terminal 20 (see FIG. 1).

The learning result registration support apparatus 40 determines whether or not there is no correction until a predetermined period elapses from the notification (step S6).

In a case where a negative result is obtained in step S6, the learning result registration support apparatus 40 receives a correction instruction from a teacher (step S7). After then, the learning result registration support apparatus 40 returns to step S5 and notifies again a student registered in a group of the corrected content.

In a case where a positive result is obtained in step S6, the learning result registration support apparatus 40 proceeds to step S8. The correction may be received at any time. In this case, execution of step S6 and step S7 becomes unnecessary.

In step S8, the learning result registration support apparatus 40 determines whether or not there is no unprocessed group.

In a case where a negative result is obtained in step S8, the learning result registration support apparatus 40 returns to step S2 and receives another group image.

In a case where a positive result is obtained in step S8, the learning result registration support apparatus 40 regards an unregistered student as an absentee and notifies the student (step S9). The notification is transmitted to the corresponding student terminal 20 (see FIG. 1). In a case where there is an error in the notification as an absentee, the learning result registration support apparatus 40 receives a correction of a member registration.

In a case of FIG. 4, the learning result registration support apparatus 40 receives image data of an output submitted from each group after step S9 (step S10). Meanwhile, the output may be submitted to the teacher each time presentation of the corresponding group is completed, or may be submitted before the presentation.

In a case of FIG. 4, the learning result registration support apparatus 40 collectively receives image data of the output after assignment of students to all groups is completed. Meanwhile, the learning result registration support apparatus 40 may receive the image data of the output every time the output is submitted.

The learning result registration support apparatus 40 which receives the image data of the output extracts a feature quantity from the image data of the output (step S11).

Next, the learning result registration support apparatus 40 performs collation with a group image by using the extracted feature quantity, and links and presents the image data of the output to a group corresponding to the group image (step S12). For example, as illustrated in FIG. 5, the feature quantity extracted from the image data 550 obtained by imaging the entire output is collated with the output image 520 included in the group image 500, and the image data of the output is linked to a group image having high similarity.

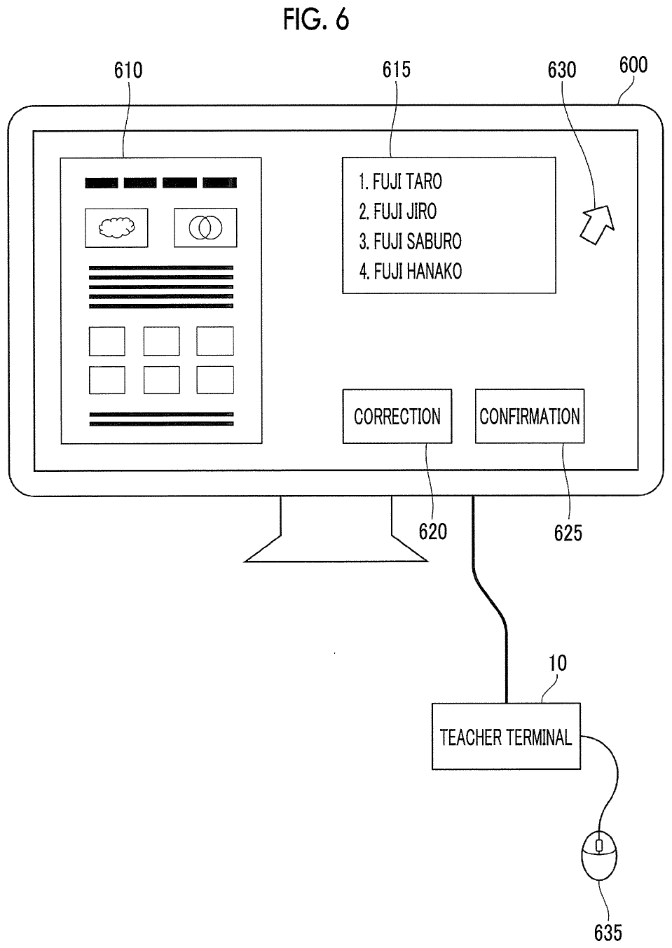

FIG. 6 is a diagram for explaining an example of a screen presenting a linking relationship between an output and a student.

In the example illustrated in FIG. 6, a display 600 connected to the teacher terminal 10 displays an output image 610 and a student name list 615 corresponding to a linked group. In a case of FIG. 6, a correction button 620 and a confirmation button 625 are also displayed.

In a case of correcting a linking relationship, a teacher may move a pointer 630 over the correction button 620 and may click the correction button 620. In order to move the pointer 630, a mouse 635 connected to the teacher terminal 10 is used. The mouse 635 is an example of the operation receiving unit described above.

In a case of confirming the linking relationship, the teacher moves the pointer 630 over the confirmation button 625 and clicks the confirmation button 625.

Returning to the description in FIG. 4.

In a case where the click of the confirmation button 625 (see FIG. 6) is detected for all groups, the learning result registration support apparatus 40 confirms the linking relationship between the output and the student for all the groups (step S13).

As described above, a record in which a member and an output of a group are associated with each other is generated in real time by the learning result registration support apparatus 40 which receives a group photo of the member constituting the group and image data of the output. For this reason, while a student stays at a venue in which the output is presented, it is possible to confirm the generated record and to correct an error.

In a case of generating the record in which the member and the output of the group are associated with each other later, verification of a factual relationship may become difficult. Meanwhile, in a case of using the learning result registration support apparatus 40, it is possible to confirm and correct the generated record at the venue in which the involved person is present. For this reason, accuracy of the generated records is increased.

### Exemplary Embodiment 2

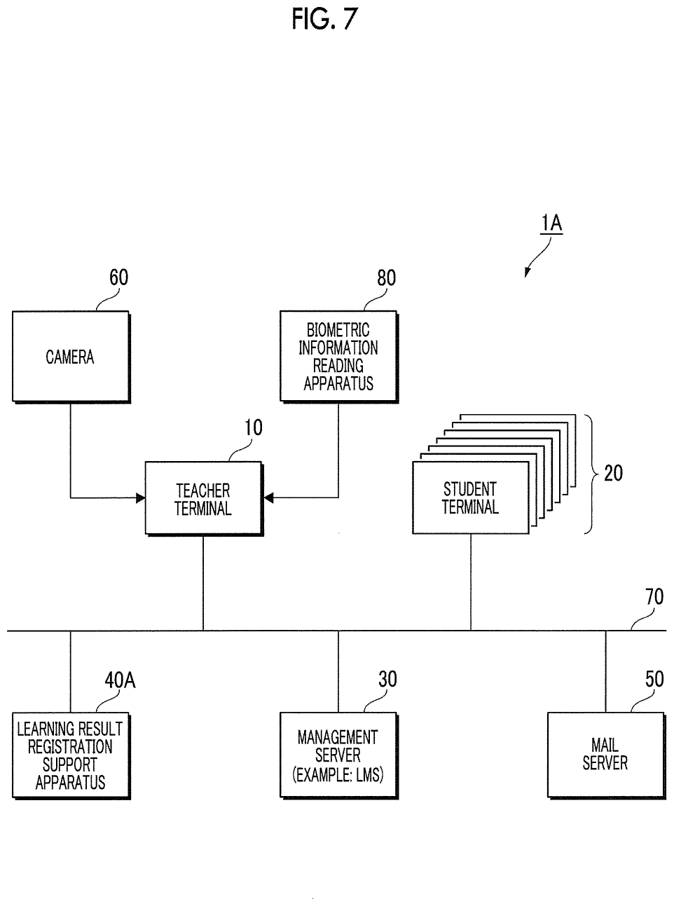

FIG. 7 is a diagram for explaining a conceptual configuration of an information processing system 1A used in Exemplary Embodiment 2. In FIG. 7, the reference numerals corresponding to those in FIG. 1 are illustrated.

A configuration of the information processing system 1A according to the present exemplary embodiment is different from the information processing system 1 (see FIG. 1) according to Exemplary Embodiment 1 in that there is a biometric information reading apparatus 80. In other words, the information processing system 1A in the present exemplary embodiment has the configuration in which the biometric information reading apparatus 80 is added to the information processing system 1.

In order to use biometric information for authenticating a student, the biometric information reading apparatus 80 is added. In a case of the present exemplary embodiment, a fingerprint is used for the biometric information. Meanwhile, it is also possible to use other biometric information such as a vein, an iris, or the like.

In the present exemplary embodiment, confirmation of an image of an output by a student himself/herself and authentication of the student by the biometric information are executed at the same time, and the output and the authenticated student are linked. Specifically, the student authenticated from the biometric information is linked to the image of the output displayed at the time of reading the biometric information.

In FIG. 7, in order to express the function different from Exemplary Embodiment 1, 40A is used for a reference numeral of the learning result registration support apparatus. The learning result registration support apparatus 40A is also an example of an information processing apparatus which supports registration of a result of a group activity.

In a case of the present exemplary embodiment, the biometric information reading apparatus 80 is connected to the teacher terminal 10.

Meanwhile, the biometric information reading apparatus may be directly connected to the learning result registration support apparatus 40A or may be directly connected to the network 70. In a case of the present exemplary embodiment, biometric information of each student is managed by the management server 30 or the like.

In a case of the present exemplary embodiment, authentication of a student using biometric information read by the biometric information reading apparatus 80 is executed by the learning result registration support apparatus 40A.

In this manner, in the present exemplary embodiment, it is not necessary to image a group photo of a member constituting a group. Therefore, the camera 60 in the present exemplary embodiment is for imaging an output.

Configuration of Each Apparatus

A hardware configuration of the teacher terminal 10 (see FIG. 7), the student terminal 20 (see FIG. 7), the management server 30 (see FIG. 7), and the learning result registration support apparatus 40A (see FIG. 7) according to the present exemplary embodiment is the same as the configuration described in Exemplary Embodiment 1. For example, the learning result registration support apparatus 40A includes the control unit 401 (see FIG. 2), the storage unit 402 (see FIG. 2), the communication interface 403 (see FIG. 2), and the like.

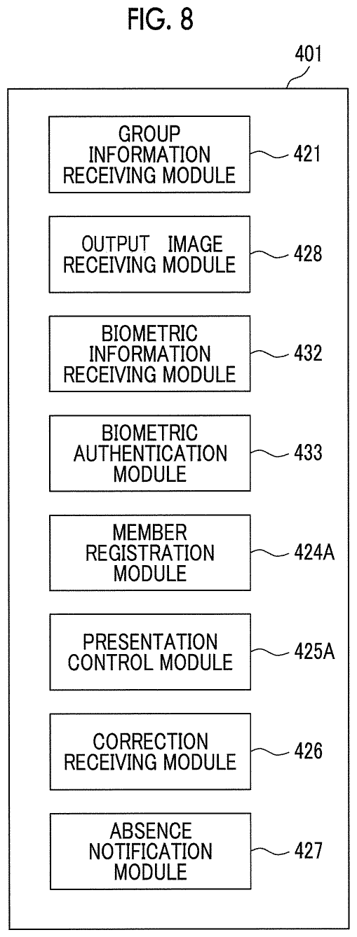

FIG. 8 is a diagram for explaining an example of a functional configuration of the control unit 401 (see FIG. 2) constituting the learning result registration support apparatus 40A (see FIG. 7) used in Exemplary Embodiment 2. In FIG. 8, the reference numerals corresponding to those in FIG. 3 are illustrated.

A functional module illustrated in FIG. 8 is realized by a program being executed by the CPU 411 (see FIG. 2). The module illustrated in FIG. 8 is a part of the program executed by the control unit 401.

As described above, in a case of the present exemplary embodiment, linking of a student to an output is substantially completed by reading biometric information.

For this reason, the functional module illustrated in FIG. 8 is configured by a part of the functional module illustrated in FIG. 3 and a module related to biometric authentication.

The control unit 401 according to the present exemplary embodiment functions as the group information receiving module 421, the output image receiving module 428, a biometric information receiving module 432 which receives biometric information, a biometric authentication module 433 which authenticates a student by using the received biometric information, a member registration module 424A which registers the authenticated student in a group linked to image data of an output, a presentation control module 425A, the correction receiving module 426, and the absence notification module 427.

The group information receiving module 421 is also used to receive information on a prospective participant participating in group learning, the number of groups used in the group learning, and the like.

The output image receiving module 428 receives image data obtained by imaging the entire output. In a case of the present exemplary embodiment, the received pieces of image data are respectively linked to different groups.

The biometric information receiving module 432 executes a process of receiving biometric information read by the biometric information reading apparatus 80 (see FIG. 7). In a case of the present exemplary embodiment, since the biometric information reading apparatus 80 is connected to the teacher terminal 10 (see FIG. 7), the biometric information is received via the teacher terminal 10 and the network 70 (see FIG. 7).

The biometric authentication module 433 collates the received biometric information with biometric information managed by the management server 30 (see FIG. 7) to authenticate a student. The biometric authentication module 433 is an example of an authentication section.

The member registration module 424A reads the biometric information and executes linking the biometric information to a group at the same time. Meanwhile, the registration is a temporary registration. The member registration module 424A is an example of a linking section.

The presentation control module 425A causes the teacher terminal 10 to display information of a student registered as a member of the same group together with an image of an output. A reason is that the biometric information reading apparatus 80 is connected to the teacher terminal 10. The presentation control module 425A is an example of a presentation section.

In a case of using a fingerprint sensor of a smartphone which a student carries, a linking relationship with a group is displayed on the smartphone which the student operates. In a case of using a fingerprint sensor of a smartphone which a student carries, an image of an output may also be displayed on the smartphone of the student.

In order to use the fingerprint sensor of the smartphone for registration to the group, an exclusive program which enables cooperation with the learning result registration support apparatus 40A may be installed on the smartphone. The management server 30 manages information identifying the smartphone used by the student.

In a case where identification by fingerprint authentication succeeds while displaying the image of the output, the smartphone on which the exclusive program is installed notifies the learning result registration support apparatus 40A of this identification success. The learning result registration support apparatus 40A registers the student associated with the smartphone which is a transmission source of the notification as a member of the group linked to the image of the displayed output. Here, the smartphone is an example of the student terminal 20 (see FIG. 7).

The correction receiving module 426 and the absence notification module 427 are the same as in Exemplary Embodiment 1. After receiving a correction by the correction receiving module 426 or a correction after the notification by the absence notification module 427, a linking relationship between image data of the output and the student for each group is determined.

### Example of Processing Operation

Hereinafter, a processing operation executed in Exemplary Embodiment 2 will be described.

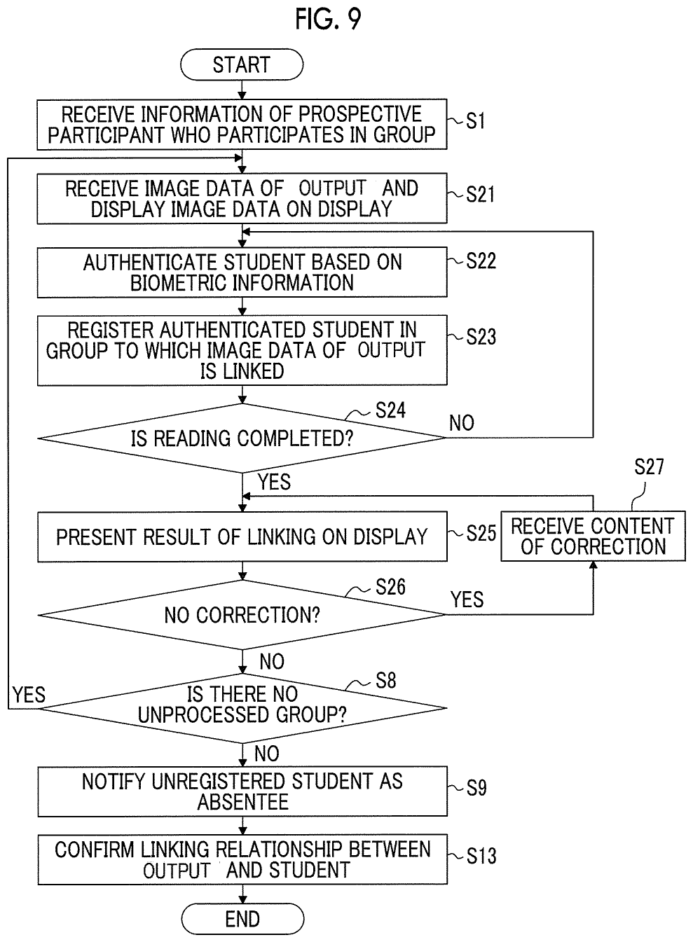

FIG. 9 is a flowchart illustrating an example of a processing operation executed by the learning result registration support apparatus 40A (see FIG. 7) used in Exemplary Embodiment 2. In FIG. 9, the reference numerals corresponding to those in FIG. 4 are illustrated. A symbol S illustrated in the flowchart means a step.

First, the learning result registration support apparatus 40A receives information of a prospective participant who participates in group learning (step S1).

Next, the learning result registration support apparatus 40A receives image data of an output and displays the image data on a display (step S21). In a case of the present exemplary embodiment, the image of the output is displayed on a display of the teacher terminal 10 (see FIG. 7).

In a case of receiving biometric information while displaying the image of the output on the display of the teacher terminal 10, the learning result registration supporting apparatus 40A authenticates a student based on the received biometric information (step S22).

Thereafter, the learning result registration support apparatus 40A registers the authenticated student in a group to which the image data of the output is linked (step S23).

Next, the learning result registration support apparatus 40A determines whether or not the reading is completed (step S24). The determination is performed based on whether or not a button for instructing completion of the reading displayed on the display is operated.

In a case where a negative result is obtained in step S24, the learning result registration support apparatus 40A returns to step S22.

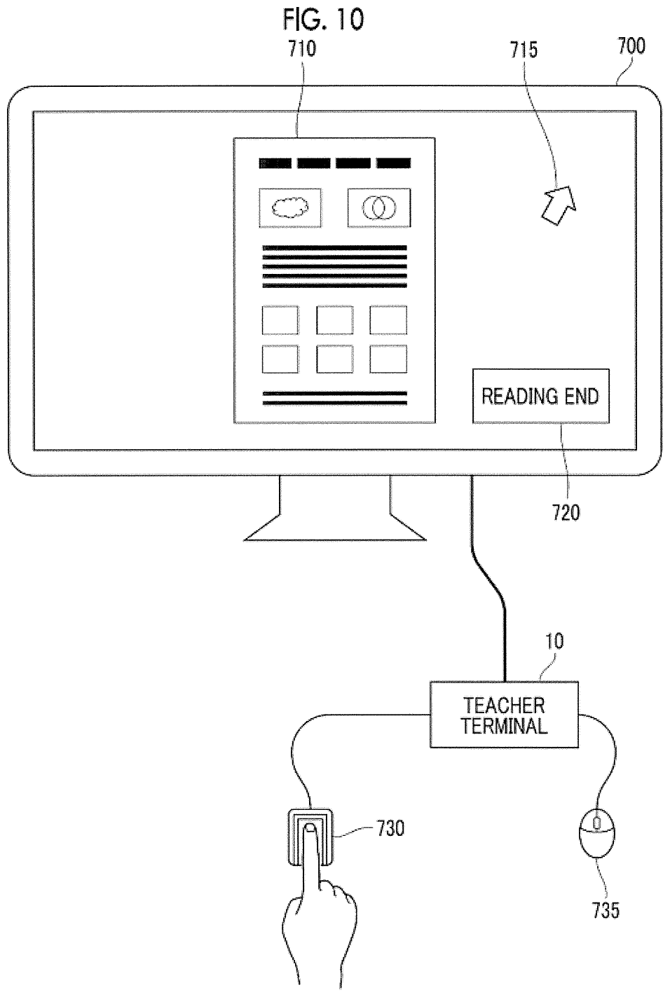

FIG. 10 is a diagram for explaining a scene of reading a fingerprint of a student.

In a case of FIG. 10, a display 700 is connected to the teacher terminal 10, and an output image 710 is displayed on the display screen.

A student who participates in group learning confirms the output image 710 displayed on the display 700. The student who confirms that the output image 710 is an image of a group to which the student belongs covers a fingerprint reading apparatus 730 with a finger of the student. Each time the student covers the fingerprint reading apparatus 730 with the finger, the fingerprint reading apparatus 730 reads a fingerprint. The fingerprint reading apparatus 730 is an example of the biometric information reading apparatus 80 (see FIG. 7).

The reading of the fingerprint is continued until a button (hereinafter, referred to as “reading end button”) 720 indicating completion of the reading displayed on the display 700 is clicked with a pointer 715. The display 700 is an example of a display unit.

The movement or clicking of the pointer 715 is realized by operating a mouse 735 connected to the teacher terminal 10. The mouse 735 is an example of the operation receiving unit described above.

Returning to the description in FIG. 9.

In a case where a positive result is obtained in step S24, the learning result registration support apparatus 40A presents a result of the linking on the display (step S25).

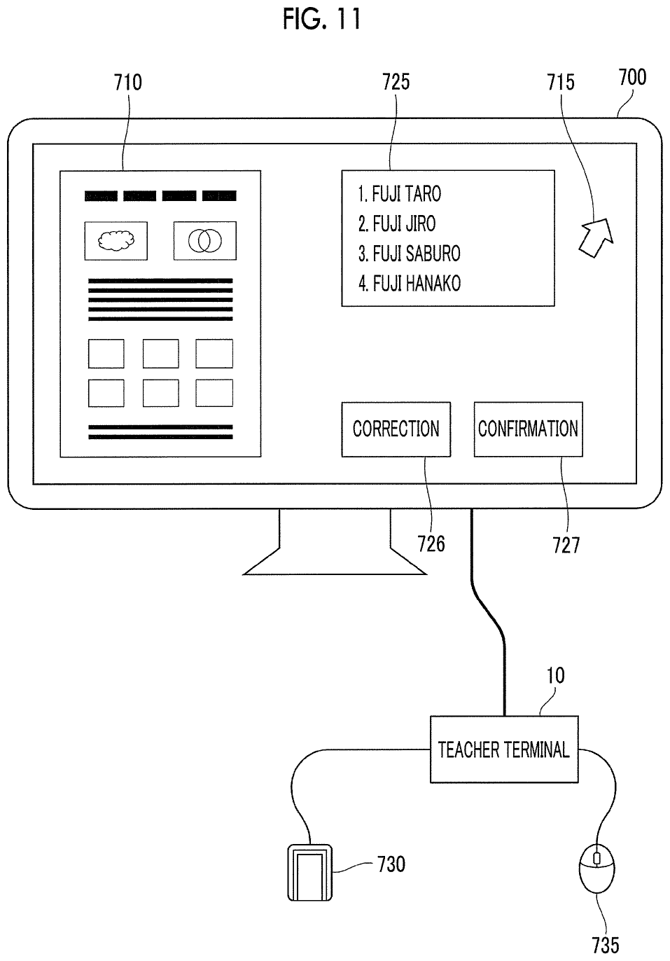

FIG. 11 is a diagram for explaining an example of a screen displayed after reading of a fingerprint is completed. In FIG. 11, the reference numerals corresponding to those in FIG. 10 are illustrated.

As illustrated in FIG. 11, the display 700 displays a student name list 725 linked to the output image 710. The student indicated in the student name list 725 is a student specified by fingerprint authentication. In a case of FIG. 11, names of four persons are displayed.

The display 700 in FIG. 11 also displays a button 726 operated in a case of instructing to correct a content of the student name list 725 and a button 727 operated in a case of instructing to confirm a content after the correction.

Returning to the description in FIG. 9.

In a case where display of the result of the linking is started, the learning result registration support apparatus 40A determines whether or not there is no correction (step S26).

In a case where clicking of the button 726 (see FIG. 11) for instructing a correction is detected, the learning result registration support apparatus 40A obtains a negative result in step S26. In this case, the learning result registration support apparatus 40A receives a content of the correction (step S27), and then returns to step S25.

On the other hand, in a case where clicking of the button 727 (see FIG. 11) for instructing a confirm is detected, the learning result registration support apparatus 40A obtains a positive result in step S26. In this case, the learning result registration support apparatus 40A determines whether or not there is no unprocessed group (step S8).

In a case where a negative result is obtained in step S8, the learning result registration support apparatus 40 returns to step S21, receives image data of an output of another group, and displays the image data on the display.

On the other hand, in a case where a positive result is obtained in step S8, the learning result registration support apparatus 40 regards an unregistered student as an absentee and notifies the student (step S9).

In a case where a correction related to the student who is regarded as an absentee is also completed, the learning result registration support apparatus 40 determines a linking relationship between the output and the student (step S13).

As described above, since an association between an output and a student is registered in front of an eye of the student who covers the fingerprint reading apparatus 730 (see FIG. 10) with a finger while checking the output image 710 (see FIG. 10), the association is presented in real time.

For this reason, even in a case where there is an error in a content of the registration, it is possible to perform a correction at the corresponding place.

### OTHER EMBODIMENTS

Although the exemplary embodiments of the present invention are described above, a technical scope of the exemplary embodiments of the present invention is not limited to the scope described in the exemplary embodiments described above. Various modifications or improvements are added to the exemplary embodiments described above within the technical scope of the exemplary embodiments of the present invention, and are apparent from the description of the claims.

The exemplary embodiment describes an example in which a student who participates in group learning is linked to image data obtained by imaging an output of the group learning. However, the above-described technology may be used in a case of linking a participant of a group work to image data obtained by imaging an output of the group work.

In the case of the exemplary embodiment described above, the learning result registration support apparatuses 40 (see FIG. 1) and 40A (see FIG. 7) are treated as exclusive apparatuses independent from the management server 30 (see FIG. 1) and the like. However, a part or all of the function of the learning result registration support apparatus 40 may be executed by the teacher terminal 10, the student terminal 20, the management server 30, and the like. For example, the function of the learning result registration support apparatus 40 may be realized by collaboration with another terminal.

In addition, the learning result registration support apparatus 40 may be realized as a cloud server or an on-premises server.

In Exemplary Embodiment 1 described above, a student is authenticated by using an image of a face imaged in a group photo, but the student may be authenticated by extracting an image of a student card held by the student, an image of a name card of the student, a barcode distributed to the student for each group, an images of a quick response (QR) code or another code, and the like.

In Exemplary Embodiment 1 described above, a feature quantity is extracted from an image obtained by imaging an entire output, and collation with an image of the output captured in the collective image is performed by using the extracted feature quantity. Meanwhile, the image obtained by imaging the entire output may be used instead of the feature quantity.

In Exemplary Embodiment 1 described above, the feature quantity of the image of the output is extracted from the image obtained by imaging the entire output. Meanwhile, the feature quantity of the image of the output may be extracted from an area designated in the group image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an authentication section that authenticates a member who gives a presentation based on information obtained at a place in which the presentation is given;
a linking section that links the authenticated member to an image of the presentation; and
a presentation section that presents a link between the authenticated member and the image of the presentation.

2. The information processing apparatus according to claim 1,
wherein the authentication section processes a second image obtained by imaging a status of the presentation to authenticate a member.

3. The information processing apparatus according to claim 2,
wherein at least a part of the presentation and a part of the member are included in the second image, and the linking section links the member authenticated from the second image to the image of the presentation including a feature quantity common to the second image.

4. The information processing apparatus according to claim 2,
wherein the second image is a group photo of members constituting a group.

5. The information processing apparatus according to claim 1,
wherein the linking section links a member of which biometric information is read while displaying a captured image of the presentation to the image of the displayed presentation.

6. The information processing apparatus according to claim 5,
wherein the biometric information is read at the place in which the presentation is given.

7. A non-transitory computer readable medium storing a program causing a computer to execute:
a function of authenticating a member who gives a presentation based on information obtained at a place in which the presentation is given;
a function of linking the authenticated member to an image of the presentation; and
a function of presenting a link between the authenticated member and the image of the presentation.

8. An information processing apparatus comprising:
authentication means for authenticating a member who gives a presentation based on information obtained at a place in which the presentation is given;
linking means for linking the authenticated member to an image of the presentation; and
presentation means for presenting a link between the authenticated member and the image of the presentation.
